(19) United States
(12) Patent Application Publication
(10) Pub. No.: US 2017/0293906 A1
(43) Pub. Date: Oct. 12, 2017

(54) POINT-OF-SALE CYBERSECURITY SYSTEM

(71) Applicant: Andrei Komarov, Santa Monica, CA (US)

(72) Inventor: Andrei Komarov, Santa Monica, CA (US)

(21) Appl. No.: 15/228,976

(22) Filed: Aug. 4, 2016

Related U.S. Application Data
(60) Provisional application No. 62/319,231, filed on Apr. 6, 2016.

(51) Int. Cl. G06Q 20/20; H04L 29/06

(52) U.S. Cl. CPC G06Q 20/206; H04L 63/1425; H04L 63/102

(57) ABSTRACT

Protection of POS terminals is enabled by multi-pronged security apparatus that includes: initializing the POS terminal and storing a profile of the terminal, and thereafter monitoring for any change in the POS terminal environment; inserting a bait into the memory (e.g., RAM) of the POS terminal, and monitoring the bait, such that when it is detected that the bait has been read, an indication of potential intrusion is issued; and providing communication channel between a monitoring center and plurality of POS systems, so that whenever an indication of potential intrusion is issued by a terminal, it is sent to the monitoring center and the monitoring center alerts the administrators of the participating POS systems, and the affiliated merchants about identified attacks to enable a response or removal of compromised terminals from service, including but not limited to temporary payment transactions blocking.

### RELATED APPLICATION

This application claims priority benefit from U.S. Provisional Patent Application Ser. No. 62/319,231, filed on Apr. 6, 2016, the content of which is incorporated herein by reference in its entirety.

### BACKGROUND

### 1. Field of the Invention

This disclosure relates to security protection of Point-of-Sale (POS) terminals and systems, and data transmitted and received by such devices and systems.

### 2. Related Art

Generally POS systems are servers that are connected to a plurality of POS terminals. The POS terminals allow customers to make payments using a variety of payment instruments such as credit cards, debit cards, smart cards, ATM cards, etc. The magnetic stripe on the back of these cards is read by swiping past a magnetic reading head of the POS terminal or external devices, connected to POS terminal for such operation. The read data is stored and is used by the POS system to consummate the transaction. The data or part of it can also be saved to other systems for further use, e.g., back office systems, loyalty program management systems, etc.

There are up to three tracks on magnetic cards, known as tracks 1, 2, and 3. Track 3 is virtually unused by the major worldwide networks, and often isn't even physically present on the card by virtue of a narrower magnetic stripe. Point-of-sale card readers almost always read track 1, or track 2, and sometimes both, in case one track is unreadable. The minimum cardholder account information needed to complete a transaction is present on both tracks. Track 1 has a higher bit density (210 bits per inch vs. 75), is the only track that may contain alphabetic text, and hence is the only track that contains the cardholder's name.

The attacks on retailers and small businesses having POS terminals are significantly growing, affecting customers, processing companies and financial institutions. The growing threat for such type of devices include: interception of payment and other types of data, using infection of the terminal by malware. The malware enables extraction of temporary data that is stored in RAM for use by legitimate preinstalled applications and systems in the normal flow of a payment transaction. After the payment card is swiped, the track data, in a form of blocks of payment data, is temporary stored in terminal's RAM, which allows malware to exfiltrate it by the predefined signatures and data formats description.

Modern processing companies and financial institutions, and even owners of the business in some cases have no tools to monitor the actual security level of Point-of-Sale environments, as traditionally such businesses are franchise-based, having decentralized security, or it is technically impossible to analyze the security of particular payment terminal for the processing company and financial institution, as they are located on different organizational levels and network topologies, which makes the problem of customers personal and payment data protection very complicated.

This security problem is partially regulated today on administrative (regulatory) level only. Penalties and/or fines are imposed on merchants only if data leak has happened because of poor security mechanisms. However, these penalties are imposed after the fact—the customers' data has already been compromised.

In many cases, successful data theft incidents happen on the terminals having traditional security solutions installed on them. This tends to show that general security products are not fully adapted for POS risk model. Moreover, the specifics of such environments make it impossible to install additional layers of security on the POS devices, because of limited calculation resources, hardware specification, software modules support, used operating systems specifics, and topology of the network.

As noted above, one specific attack is a piece of malware software that reads the stored track 1 and/or track 2 data and sends the data to the bad actor. Since the track 1 and track 2 data conform to a specified format that is used worldwide, it is easy for the malware to identify that data, read it, and send it to the bad actor. To ensure that the payment information transmitted from the POS terminals to a payment center is not intercepted at this stage, there should be added additional layers of cybersecurity on POS terminal, besides electronic components, preventing device tempering. Because there is no additional verification mechanisms, the bad actor may record the intercepted track data on another plastic card and use it for further unauthorized transactions.

The industry experts proposed EMV (Europay, MasterCard and Visa is a global standard for cards equipped with computer chips and the technology used to authenticate chip-card transactions) as new technological solution for adding additional security mechanisms into modern plastic cards and linked processing institutions with them. However, not every payment merchant and processing institution is ready to integrate it or to fully support it today. While it is planned to be integrated close to the year 2022, this solution is very expensive for businesses.

Moreover, EMV cards generally have identical magnetic strip track data encoded on the chip, which is read as part of the normal EMV transaction process. If an EMV reader is compromised to the extent that the conversation between the card and the terminal is intercepted, then the attacker may be able to recover both the track data and the PIN, allowing construction of a magnetic stripe card, which, while not usable in a chip and PIN terminal, can be used, for example, in terminal devices that permit fallback to magstripe processing for foreign customers without chip cards, and defective cards. This is the form of attack that was reported to have taken place against Shell terminals in May 2006, when they were forced to disable all EMV authentication in their filling stations after more than £1 million was stolen from customers.

Another problem is generally referred to as skimming. Skimmers are devices that thieves secretly attach to POS terminals in order to capture and ultimately clone legitimate cards. Sophisticated skimmers also have transmitters that wirelessly transmit the captured data, without the need for the bad actor to return to retrieve the skimmer. The skimmer does not interfere with the normal functioning of the terminal, so that neither the user nor the terminal owner can tell that anything is wrong, while in fact the skimmer transmits the track data of each card swiped at the terminal.

Thus, what is needed is a cheaper and simpler security solution, providing a very high-level of security of the merchants with POS terminals. The method and apparatus should allow for protecting POS terminals in a cost-efficient and easily-implemented way, without any additional systems modification on the POS processor's side. Proper implementation of security should allow to significantly increase security level of POS against actual cybersecurity threats, and to immediately identify and report any security breach.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Aspects of this disclosure allow building secure ecosystems for POS environments, providing specialized mechanism for the interested parties to control the security of its elements.

In order to protect such environments efficiently, a comprehensive cybersecurity system is provided, adapted for the specifics of POS terminals and the type of cyber-attacks directed at POS terminals.

Various embodiments of the invention relate to method and apparatus that protect POS terminals from cybersecurity threats, related to payment data compromise in RAM memory (so called “RAM Scrapping Attacks”) and unauthorized access to stored or processed information on the terminal. The embodiments detect and alert of intrusions and system compromises.

The disclosed embodiments provide a multi-pronged approach to POS terminal security.

According to one aspect, one prong comprises initializing the POS terminal and storing a profile of the terminal, which indicates which hardware and software modules of the POS terminal are legitimate. Then, the environment of the POS terminal (i.e., hardware and software modules operating or connected to the POS terminal) is constantly monitored and compared to the stored profile. If it is detected that the environment of the POS terminal is different from the stored profile, an indication of potential intrusion is issued.

According to another aspect, one prong comprises inserting a bait into the storage (e.g., RAM) of the POS terminal, and monitoring the bait. If it is detected that the bait has been read, an indication of potential intrusion is issued. According to one embodiment the bait is in the form of fake (e.g., randomly generated) data stored in the format of track 1, track 2, or both track 1 and track 2.

According to a further aspect, one prong comprises providing communication channel between a monitoring center and plurality of POS systems. Whenever an indication of potential intrusion is issued by a terminal, it is sent to the monitoring center. The monitoring center may then alert the administrators of the POS terminals, will block further transactions from the issuing terminal or from a selected group of terminals (which includes selecting all the terminals), or place off-line the issuing terminal or a selected group of terminals (which includes selecting all the terminals). The monitoring center may also distribute the information about the source and/or type of the attack to other participants of the system.

Further aspects of the invention can be applied to any POS, represented as ticket vending machine, with computerized elements and payment terminal, accepting payment cards, embedded systems, used for payment cards processing, and other devices, having similar functions. For example, the Square Reader from Square, Inc., of San Francisco, Calif., works with the Square Register app to allow everyone to take payments on their smartphone or tablet. In such environment, the Square Reader reads the track 1/track 2 data and sends it to the phone/notepad memory for processing. If the phone or notepad is compromised, the track 1/track 2 data can be easily read and sent to the bad actor using the wireless transmission capabilities of the phone/notepad. Using any of the disclosed embodiments, such action can be prevented and users can be alerted to such an attempt.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a block diagram illustrating major elements according to one embodiment of the invention.

FIG. 2 is a schematic of the internal parts of a POS terminal according to one embodiment.

### DETAILED DESCRIPTION

By default, POS systems don't have any cybersecurity components, but rather providing just mechanism for transactions management. Some of the systems may have embedded hardware security and electronic security components, mostly targeted at physical security of the terminal from any harmful activity. However, the latest trends show that the POS infrastructure is vulnerable to multivector cyber attacks, targeted at payment data exfiltration, i.e., reading and forwarding the track data.

The following detailed description of aspects of the invention provides for adding cybersecurity component onto the POS system, thereby preventing local and remote cyber attacks against POS terminal or their group. The disclosed embodiments provide a multi-pronged approach to terminal security, including detecting malware attack on a terminal, detecting skimmer or tampered devices (having connection with the terminal) or other “hardware” attacks on a terminal (especially attacks targeting Track1/Track2 data), and alerting merchants about identified attacks to enable a response or removal of compromised terminals from service.

According to one embodiment, the security mechanism is implemented using a system having a software client that is installed on the POS terminal connected to the POS system. The software client is preferably installed prior to shipping the terminal to the customer. Alternatively the software client may be installed by the customer prior to connecting the terminal to the network, thus ensuring that no malware exists on the terminal. When updating or upgrading a terminal that is already connected and operated within a card-payment system, it is best to disconnect the terminal from the system, wipe it clean, reinstall the operating system and other application software, and the security software client. Then the terminal can be reconnected, again ensuring that no malware exists on the terminal.

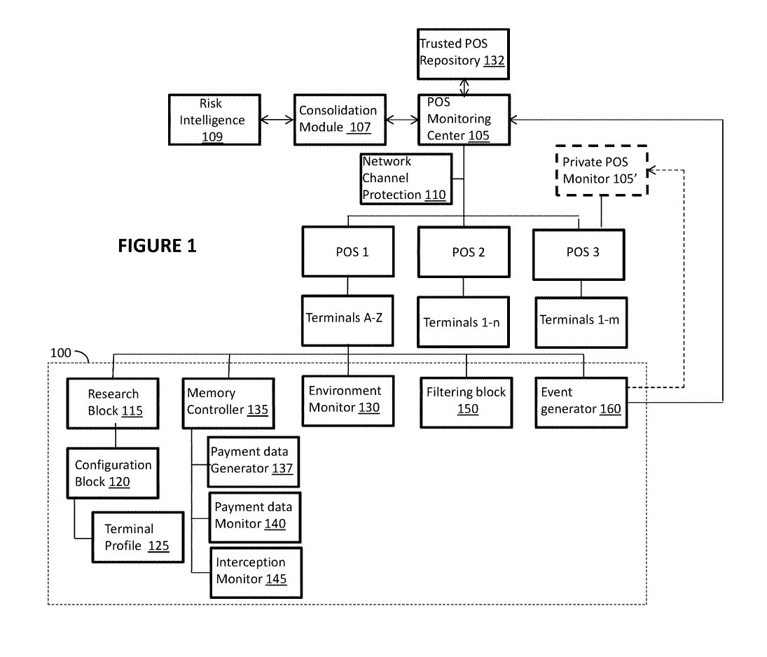

A general block diagram of the system is shown in FIG. 1, including various modules installed according to one embodiment. FIG. 1 illustrates three POS1-3 as an example, but the system may include many more POSs. Each POS may belong to one merchant, e.g., POS 1 may belong to Sears while POS 2 may belong to Walmart. Each of the POS1-3 is coupled to several POS terminals, e.g., in FIG. 1, POS 1 is coupled to POS terminals A-Z, POS 2 is coupled to terminals 1-n, and POS 3 is coupled to terminals 1-m. In the example of FIG. 1, the POS1-3 are also linked (e.g., via the Internet) to POS monitoring center 105, which is protected by network channel protection 110. As shown by the broken-line block, in some embodiments a POS may be connected to a private POS monitor 105′ instead, or in addition to connecting to POS monitoring center 105. The private POS monitor 105′ may be in the form of a server owned by the same entity owning the corresponding POS, in case such entity does not want to share its information with outsiders.

The various modules illustrated in FIG. 1 will now be described in conjunction with their function. Each of the modules shown in FIG. 1 may be implemented as a piece of software, hardware, e.g., in a FPGA, or a combination of software and hardware. Also, while the most benefit may be achieved using all of the modules that are described in FIG. 1, certain embodiments may be implemented using only selected ones of these modules, albeit with potential reduction in security. Notably, implementing all the modules of FIG. 1 provides a multi-pronged approach for identifying and preventing bad actor attacks on all of the POS terminals participating in this secured system. Importantly, using all of these module prevent both software attack, such as installation of malware, and hardware attacks, such as installation of skimmers (having connection to the terminal) or tampered devices (example: modified PINpad, having customized malicious firmware, having a connection with legitimate terminal). In FIG. 1, broken-line box 100 encompasses all of the modules that may be installed in a POS terminal, although in some embodiments only a subset of these modules may be installed. In other example, the modules within broken-line box 100 may be implemented as an app for operating within a phone or notebook used for processing payment cards.

### Discovery and Configuration

The discovery and configuration feature aims at preventing and identifying any unauthorized changes (software and/or hardware) to the POS terminal. According to one disclosed embodiment, after the client is installed on the Point-of-Sale terminal, a so called research or discovery procedure is launched by the research block 115, to discover all of the components and modules available on the terminal. According to this embodiment, all discovered components and modules will be assumed to be legitimate, which is one reason why it is preferred to install this client before the terminal is placed in service. After this research is finished, using the discover components and modules, the system creates a list of trusted applications, software modules and libraries, which are identified as being authorized for legitimate work. Each of the listed entity also receives its own assigned unique hash and description. This list also includes the details about the connected hardware devices, such as pinpads, pin-entry devices (PEDs) and external POS terminals, in order to monitor incidents, related to possible device replacement on unauthorized or tampered device. The trusted applications, software modules, libraries, and connected hardware devices may be referred to as allowed or trusted entities and may be listed in an easily searchable index, each with its assigned hash ID.

The list of allowed entities is then passed to a configuration block 120, where the operator may define rule sets for each entity, along with their allowed network activity. Such procedure creates the profile 125 for the particular terminal. In some embodiments, the profile 125 may be distributed or installed across all available terminals having the same hardware and software configuration. In other embodiments the profile 125 may be distributed or installed across all available terminals, but thereafter each may be tailored to its corresponding individual terminal. The profile can be created for particular terminal, having input elements for the checksums of the legitimate Point-of-Sale software, which it should support. The list of industry specific software modules with checksums forms trusted point-of-sale software repository. This repository can be updated by the operator, or using third party sources, such as official manufactures data exchange and various technology partnerships.

### Environment Monitoring

The environment monitoring block 130 monitors the integrity of the POS terminal and its behavior based on the chosen profile 125. Thus, if the environment monitor 130 detects a configuration that is different from the profile 125, the environment monitor alerts for possible intrusion. For example, if a skimmer is connected to the terminal, the configuration of the terminal is changed from the saved profile 125. Thus the environment monitor will detect that change and issue an alert. In this sense, the research block 115 and the environment monitor 130 form a unit that maintains the integrity of the POS monitor, from both hardware and software stand point.

The environment monitoring block 130 also communicates with the trusted POS software modules repository 132. In one embodiment the trusted POS repository 132, is a library of the legitimate software modules and keeps hash sums and various meta data on verified POS related software and firmware components of various vendors. It may include official vendors repositories and their data as well, and is stored remotely from the POS terminal, e.g., at a central location accessible to authorized terminals. In the embodiment of FIG. 1, the trusted POS repository 132 is stored at the POS monitoring center 105, and receives updates from the various legitimate registered vendors. When a vendor updates firmware, it may also update a hash checksum and upload the new hash checksum into the trusted POS repository 132. When the environment monitor 130 performs its checks, it can compare the hash checksum of the software found locally on the terminal, and compare it to that stored in the trusted POS repository 132. If the checksums are different, the environment monitor 130 may issue an alert for potential breach.

### Memory Controller

Standard antimalware programs generally look for virus signature. Thus the programs get updated constantly with new virus definitions. However, these definitions can only be developed after a virus has been identified and most likely already spread and caused damage. According to one aspect of the invention, a new approach is used that enables to detect malware even if its signature is unknown beforehand. This approach is also new in that it operates and inspects the RAM, rather than scanning the persistent memory (i.e., hard-drive) of the device (in this case, the POS terminal). This approach is also novel in that it does not look for the signature of the malware, but rather monitors specific behavior or operation to identify the existence of malware.

According to one embodiment, a trap in the form of fake data is stored in the device's RAM according to a specific format. The fake data may be generated on-board the POS terminal, or may be generated remotely, e.g., by monitoring center 105, and sent to the terminal. The data itself may be random, but it must conform to the specified format, emulating payment data. In the case of a POS terminal, the format is that of track 1, track 2, or both track 1 and track 2. Since it is fake data, legitimate processes running on the device have no reason to access and read that data. Therefore, according to one embodiment, the RAM is monitored and if a process reads specially prepared fake payment data, an indication of potential intrusion is issued, and such process can be interpreted as malicious, targeting payment data on POS terminal specifically.

According to one embodiment, the trap is set and monitored as follows. Payment data generator block 137 generates fake data emulating payment track data. Generator 137 recursively repeats own functionality during the system work, generating fake payment data during this process for additional randomization and normalization for more efficient interception of malicious event, when some malicious process will try to access such data sets. This unique block of information is known to the system, but not to potential bad actor trying to compromise this data. That is, in its normal operation, the terminal's legitimate software has no reason to access and read this fake data, since it is not related to any legitimate transaction. Conversely, a malicious operation generally looks for data signature, in this case, track 1/track 2 data format, and reads it when it encounter this signature. Thus, if the fake data is read, it must be by a malicious process. In this embodiment such an operation is identified as follows.

Memory controller 135 analyzes the terminal's memory (RAM) for the presence of payment data, such as track data (Track 1/Track 2), or other types of structured data, which should be protected. Depending on the type of the identified data it creates a signal for the payment data monitor 140, with further instructions and additional details, e.g., where this type of data was identified in address space. Payment data monitor 140 receives the signal from memory controller 135 about the appearance of potentially insecure temporary payment data and analyzes it, if it is still in memory. Payment data monitor 140 analyzes the data to be able to identify payment data in RAM for both categories of information: fake data generated by payment data generator 137 and legitimate data, received after card has been swept. This analysis avoids intercepting millions of events without any special differentiation about such operations.

Payment data interception attempts module 145 analyzes each attempt to scan the memory and to extract such type of information by signature in order to intercept it (in regard of specially generated fake payment data by the system and blocks of legitimate payment data of Point-of-Sale customers in order to differentiate it from general anomalies and to be able to delete the second category of data, temporary stored in the system, after successfully finished transactions). Specifically, interception monitor module 145 continuously checks whether any process attempts to read the fake data. If so, it recognizes such read attempt as potentially malicious attack on the POS terminal. After such signal has been received, depending on the configuration, the system may generate an alert to the merchant and other interested parties, that all the transactions after this signal should be moderated.

### Filtering Block

In standard operation, when a card is swept its track1/track 2 data is stored in RAM and is used by the terminal's legitimate application to perform the commercial transaction. When a second card is swept, its data is also stored and used by the application. However, the track 1/track 2 data of these cards is not erased, such that a single terminal may temporary store data of hundreds of cards, such that if it is infected, the malware can read the data of all of these cards. According to one embodiment, this is avoided by periodically erasing the data. In one embodiment, filtering block 150 erases temporary data from terminals memory right after it's used by installed legitimate applications. In one embodiment, when new card is sept and its track1/track2 data is sorted, filtering block 150 starts a timer for that specific card. Once the time period has passed, the data of this card is erased from the RAM. According to another embodiment, the filtering block 150 tracks the operation of the application and when the application completed its activity with respect to that card, the data is erased.

### Events Generator

As noted above, one feature of embodiments of the invention is the monitoring and notification of potential intrusions to the various POS system administrators. In this embodiment, this is accomplished by an event generator 160 that creates event notifications, depending on the identified suspicious behavior on the terminal. The event notification is forwarded to the POS monitoring center 105. When the POS monitoring center 105 receives events information, it provides it (optionally along with additional details, such as terminal description, network host, identified security event, process name, date and time) to the security events consolidation module 107. Each event will then receive an assigned priority and risk level, which is calculated by risk intelligence block 109. This risk intelligence block 109 accepts the group of events and provides the risk level on its output. Depending on the priority and risk level assigned to the event, the POS monitoring center 105 may issue an alert to all POS administrators, may stop all further transactions attempted on the infected terminals, or a group of terminals (e.g., terminals belonging to the same POS, terminals within a specified geographic location, etc.), or take the terminal or a group of terminals offline. Some additional contextual characteristics can be applied to this module for risk analysis (such as the time of the identified operation, example: normal business hours of Point-of-Sale; active connection with specific trusted ISP providers, etc.).

The above description of the elements of FIG. 1 provides an overview of a particular embodiment for protecting POS terminals and systems. It can be appreciated that in addition to setting the trap and performing the terminal's memory analysis, the disclosed embodiment further performs systematical checks of identified attempts to hook systems and legitimate POS system functions, related to keyboard, external devices (skimmers), and critical system components, which may affect the security of the POS terminal. The described mechanism helps to prevent so called “RAM Scrapping Attacks”, based on payment data interception from the POS terminal memory.

Also, by providing the event generator and the POS monitoring center, any identified knowledge about the identified threats against a particular POS terminal will be shared with the whole POS infrastructure, enabling implementation of proactive security measures. The shared knowledge may include the data about:
the time and date of the identified anomaly;
the identified attack vector (local, remote) and it's details;
the indicators of attack (source IP address, resolved hostname, attack pattern);
the indicators of compromise (malware hash, the attacked process, the host, from which it was uploaded, the host to which it planned to send the exfiltrated data);
the merchant identifier, where the anomaly was identified, with additional details about it, such as location, operators contacts, corporate officer details and industry.

The data collected by the system can be distributed across all of the hosts, which may also be located outside of the protected environment, for further risk mitigation and data breach prevention, based on the identified intelligence about the incidents and anomalies. Such approach helps to stabilize the overall security level of other POS infrastructures, using knowledge sharing approach.

This data can be automatically imported into the system installed on other POS terminals, optimizing their configured security profiles, or be shared with the used security providers and third party security solutions (Security information and event management (SIEM) systems, IDS/IPS systems, endpoint protection, etc.). Such system allows to protect not just one specific infrastructure of POS terminals, but also to strengthen the security level of the whole industry, using POS systems in its own operations.

As can be seen, the described embodiments form a comprehensive POS cybersecurity system, providing comprehensive defense against actual threats, preventing data theft from the terminal.

The chosen threat model and the structure of the implemented embodiment is highly adopted for the actual cybersecurity threats against POS terminals and environments, where they are installed, adopted for their specifics, i.e., low computing resources, integration with payment gateways, heterogeneous hardware components, third party software chain, absence of centralized security management in the most cases, etc.

The collected intelligence about the identified anomalies from POS terminal or POS system can be shared with other POS systems and even third party POS infrastructures for further risk mitigation and data breach prevention, optimizing their security profile. Such approach helps to protect not just one specific terminal, but the infrastructure of POS systems on industry level.

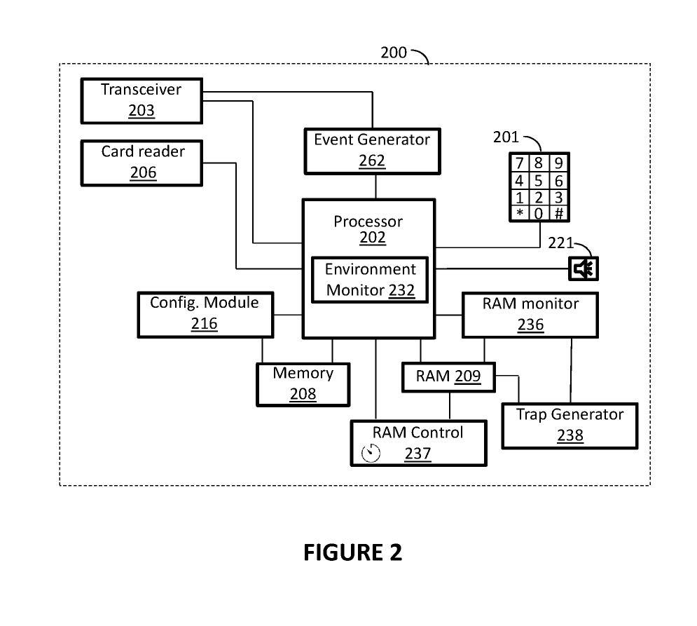

FIG. 2 is a schematic of the internal parts of a POS terminal according to one embodiment. FIG. 2 only include parts relevant to the understanding of the embodiments—other generic parts, such as a power supply, AC/DC converter, etc. are not shown so as not to clutter the schematic. As noted, these elements may be part of a stand-alone POS terminal, but may also be incorporated into a phone, a notepad, or a PC coupled to a card scanner, such as, e.g., the Square Scanner.

The operations of the terminal are executed by processor 202, generally in the form of a microprocessor or system on chip (SoC). A card reader 206 is used to scan the magnetic strip and transfer the track data to be stored in RAM 209. The operator of the terminal may input further data, such as sales price, last four digits of card, etc., using the keypad 201 (can be projected by a touch screen if using phone, notepad, etc.). The processor then executes the appropriate application to perform the transaction via transceiver 203. Transceiver 203 may be wired or wireless, using WiFi, cellular network, etc.

Several security measures are implemented in terminal 200, according to various embodiments. First, a configuration module 216 executes upon initialization of the terminal and takes inventory of all of the hardware and software modules installed on the terminal. Using the results of the survey, the configuration module 216 generates a terminal profile and stores it in persistent memory 208. Once the terminal is put on-line, the environment monitor 232 continuously checks the operational environment of the terminal and compares it to the terminal profile saved in memory 208. If the environment does not match the profile, the environment monitor issues an intrusion alert, and the event generator transmits the intrusion alerts via transceiver 203. Additionally or alternatively, the environment monitor 232 or the event generator 262 may activate alarm 221, which may be an audible alarm, a visual alarm, or both. This helps alert the operator of the terminal when a third party attempts to alter the terminal. Such an alarm is especially helpful in gas station, where it is known that third parties drive to the pump and use a generic key to install hidden skimmers inside the pump's terminal, while the pump may be hidden from the cashier by other vehicles or by an accomplice.

Another security measure implemented in terminal 200 is RAM monitor 236 and trap generator 238. Trap generator 238 generates a trap in the form of fake magnetic card track data, and saves it in RAM 209. Trap generator 238 also makes the fake track data or its address in the RAM 209 available to the RAM monitor 236. RAM monitor 236 continuously monitors read operation from RAM 209. Whenever RAM monitor 236 detects a read operation of the fake track data or at the address where the track data is stored, the RAM monitor 236 issues an intrusion alert. The intrusion alarm may be transmitted by the event generator 262 via transceiver 203. Additionally or alternatively, the RAM monitor 236 or the event generator 262 may activate alarm 221.

A further security measure implemented in terminal 200 is RAM control 237. RAM control monitors new track data stored in the RAM 209. RAM control monitors the monitors the use of the track data stored in the RAM 209 and, whenever the process using the track data terminates, RAM control 237 erases the track data from RAM 209. According to another embodiment, whenever RAM control 237 detects a new track data being stored, it activates a timer specific to that track data. When the timer reaches a preset time laps, it erases the track data. The time laps is calculated as the longest time it takes to complete a transaction, with an additional margin. According to yet another embodiment, the RAM control monitors whether a preset idle time has passed since the last reading from RAM 209. When such idle time has passed, it is assumed that all transactions using stored track data have been completed and the RAM control 237 erases all legitimate track data, other than the fake track data.

As can be appreciated from the disclosed embodiments, a computer-implemented method for protecting a point-of-sale (POS) terminal from malicious code is provided, comprising executing on a processor the steps of: generating a false transaction data; storing the false transaction data in a random access memory (RAM) of the terminal, using a predefined data format; monitoring activities on the RAM; when it is detected that a read operation read transaction data from the RAM, determining whether the transaction data read from the RAM corresponds to the false transaction data and, if so, flagging the read operation as malicious. The process may include any of the additional steps: generating and sending a report to a monitoring center; alerting other POS to the malicious operation; removing the POS terminal off-line; disallowing any further financial transaction at the POS terminal; and erasing all transaction data from the RAM. The step of erasing all transaction data from the RAM may include erasing all transaction data from the RAM according to a timer or according to monitoring activity on the POS terminal.

According to further embodiments, A non-transitory computer-readable medium for protecting a point-of-sale (POS) terminal from malicious code is provided, comprising instructions stored thereon, that when executed on a processor, perform the steps of: generating a false transaction data; storing the false transaction data in a random access memory (RAM) of the terminal, using a predefined data format; monitoring activities on the RAM; when it is detected that a read operation read transaction data from the RAM, determining whether the transaction data read from the RAM corresponds to the false transaction data and, if so, flagging the read operation as malicious. The process may include any of the additional steps: generating and sending a report to a monitoring center; alerting other POS to the malicious operation; removing the POS terminal off-line; disallowing any further financial transaction at the POS terminal; and erasing all transaction data from the RAM. The step of erasing all transaction data from the RAM may include erasing all transaction data from the RAM according to a timer or according to monitoring activity on the POS terminal.

According to yet further embodiments, a system is provided, for securing payment-card transactions, the system comprising:

(a) a point-of-sale (POS) terminal having a processor, a random access memory (RAM), and a magnetic strip reader;
(i) wherein when a user scans a payment card in the magnetic strip reader, the magnetic strip reader reads track 1, track 2, or track 1 and track 2 data from the magnetic strip of the payment card, and the processor stores the track 1, track 2, or track 1 and track 2 data in the RAM;
(ii) wherein a false track data generator generates false track 1, track 2, or track 1 and track 2 false data and stores the track 1, track 2, or track 1 and track 2 false data in the RAM; and
(iii) wherein a memory controller monitors the RAM for read operations;
(b) a computer server coupled to the POS terminal and programmed to:
(i) receive from the POS terminal alert of malicious operation; and,
(ii) notify the POS terminal of any malicious operation detected at other POS terminals.

In the above system, the alert of malicious operation may be sent whenever the memory controller identified a read operation performed on the track 1, track 2, or track 1 and track 2 false data in the RAM.

In further disclosed embodiments, a computer-implemented method for protecting a point-of-sale (POS) terminal from malicious code is provided, comprising executing on a processor the steps of: scanning the POS terminal to identify all legitimate hardware and software modules present in the POS terminal; generating and storing a profile of the terminal, which indicates legitimate hardware and software modules of the POS terminal; constantly monitoring operational environment of the POS terminal and comparing to the stored profile; whenever it is detected that the operational environment of the POS terminal is different from the stored profile, issuing an intrusion alert.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

1. A method for protecting a point-of-sale (POS) terminal from malicious attack, comprising:
generating fake data;
storing the fake data in a memory of the POS terminal;
monitoring read operations from the memory;
whenever it is detected that a read operation was performed on the fake data, issuing an intrusion alert.

2. The method of claim 1, wherein generating fake data comprises generating fake magnetic card track data.

3. The method of claim 2, wherein storing the fake data comprises storing the fake magnetic card track data in a RAM of the POS terminal.

4. The method of claim 1, wherein issuing an intrusion alert comprises sending an alert to a POS monitoring center.

5. The method of claim 4, further comprising, upon receiving the alert at the POS monitoring center, sending intrusion data from the POS monitoring center to a plurality of POS systems.

6. The method of claim 5, further comprising, upon receiving the alert at the POS monitoring center, assigning a priority level to the alert.

7. The method of claim 1, further comprising upon initialization of the POS terminal performing the operations comprising:
storing a profile of the terminal, which indicates legitimate hardware and software modules of the POS terminal;
constantly monitoring operational environment of the POS terminal and comparing to the stored profile;
whenever it is detected that the operational environment of the POS terminal is different from the stored profile, issuing an intrusion alert.

8. The method of claim 7, wherein issuing an intrusion alert comprises sending an alert to a POS monitoring center.

9. The method of claim 8, further comprising, upon receiving the alert at the POS monitoring center, sending intrusion data from the POS monitoring center to a plurality of POS systems.

10. The method of claim 9, further comprising, upon receiving the alert at the POS monitoring center, assigning a priority level to the alert

11. A point of sale (POS) terminal, comprising:
a processor;
a magnetic card reader coupled to the processor;
a persistent memory coupled to the processor;
a random access memory (RAM) coupled to the processor;
a trap generator configured to generate a fake magnetic card track data and store the fake magnetic card track data in the RAM;
a RAM monitor configured to monitor read operations from the RAM and issue an alert whenever a read operation is performed on the fake magnetic card track data.

12. The POS terminal of claim 11, further comprising a transceiver and an alert generator, the alert generator configured to transmit the alert using the transceiver.

13. The POS terminal of claim 11, further comprising a RAM control configured to erase legitimate track data after a merchant transaction using the legitimate track data has been completed.

14. The POS terminal of claim 13, wherein the RAM control comprises a timer configured to initiate each time a new track data is stored in the RAM, and wherein the RAM control is configured to erase the new track data after the timer reaches a preset time laps.

15. The POS terminal of claim 11, further comprising an audiovisual alarm configured to go off whenever an alert is issued by the RAM monitor.

16. The POS terminal of claim 11, further comprising a configuration module operating upon an initialization of the terminal to take inventory of all of hardware and software modules installed on the terminal, generates a terminal profile, and stores the terminal profile in the persistent memory.

17. The POS terminal of claim 16, further comprising an environment monitor that continuously monitors operational environment of the terminal and compare the operational environment to the terminal profile, and issue an alert whenever the operational environment differs from the terminal profile.

18. A point of sale (POS) environment, comprising:
a plurality of POS systems, each of the plurality of POS systems comprising a plurality of POS terminals, each of the plurality of terminals having a secured transaction line to the respective POS system;
a POS monitor having communication lines to the plurality of POS systems;
wherein each of the terminals further having an event generator having alert line coupled to the POS monitor and configured to transmit an alert via the alert line whenever an intrusion is suspected; and,
wherein the POS monitor is configured to transmit an alert data to the plurality of POS systems whenever it receives an alert from the event generator of any of the plurality of terminals.

19. The POS environment of claim 18, wherein the POS monitor further comprises a risk module configured to assign a priority level to an alert received from the event generator.

20. The POS environment of claim 18, wherein each of the plurality of terminals further comprises:
a processor;
a magnetic card reader coupled to the processor;
a persistent memory coupled to the processor;
a random access memory (RAM) coupled to the processor;
a trap generator configured to generate a fake magnetic card track data and store the fake magnetic card track data in the RAM;
a RAM monitor configured to monitor read operations from the Ram and issue an alert whenever a read operation is performed on the fake magnetic card track data.
